(19) United States
(12) Patent Application Publication
(10) Pub. No.: US 2026/0222193 A1
(43) Pub. Date: Jul. 30, 2026

(54) METHOD FOR UPDATING AND REVOKING SECURITY KEYS AND SENSITIVE DATA OVER REMOTE SECURE CHANNELS

(71) Applicant: CORUH ARGE VE TEKNOLOJI SANAYI TICARET LIMITED SIRKETI, RIZE (TR)

(72) Inventor: CORUH UGUR, RIZE (TR)

(21) Appl. No.: 19/152,008

(22) PCT Filed: Dec. 26, 2023
(86) PCT No.: PCT/TR2023/051716

§ 371 Date: Jul. 30, 2025

(30) Foreign Application Priority Data
Jan. 30, 2023 (TR) 2023001074

(51) Int. Cl. H04L 9/08; H04L 9/00; H04L 9/06; H04L 9/30

(52) U.S. Cl. CPC H04L 9/0891; H04L 9/0631; H04L 9/3073; H04L 9/50

(57) ABSTRACT

This invention relates to a method for updating and revoking keys and sensitive data via secure remote channels. It is applicable in the telecom sector for endpoint user devices with SIM/eSIM, smart cards carrying digital signatures distributed through USB card readers or mobile signatures, access and authorization cards, passports, digital chip-enabled identity cards, chip-enabled payment cards provided by banks for payments, OTP devices, and in vehicles and IoT (Internet of Things) within the scope of C-V2X and V2X. It also applies to certificates and keys in hardware security modules (HSM), secure elements (SE), trusted execution environments (TEE), and software-based protection solutions (Whitebox Crypto), enabling the updating of symmetric and asymmetric key pairs in these systems through a secure channel.

### TECHNICAL FIELD

The invention relates to a method for updating and/or revoking symmetric and asymmetric key pairs owned by systems in the telecom sector, applicable to various devices located at the end-user point such as SIM/eSIM in any kind of device, smart cards with digital signature distributed on USB-SIM, digital identity cards, passports, chip-based payment cards provided by banks, OTP devices, and smart cards or eSIM chips on vehicles within the C-V2X scope, as well as certificates and keys found in software and hardware secure storage areas at the endpoint.

### PRIOR ART

In the existing structure, the telecom sector uses SIM (Subscriber Identity Module)/eSIM (Embedded SIM), while the financial technology sector utilizes credit cards. Technologies enabling contactless payments in a cloud-based structure, such as HCE (Host Card Emulation), SoftPOS, POS, and OTP systems, as well as certificates in nodes for MSP (Membership Service Provider) in private blockchain networks are prevalent. Digital signature-bearing smart cards distributed on eSIM/SIM integrated devices (like eSIM/SIM integrated USB dongles) or directly on eSIM/SIM in phones, digital identity cards, passports, access and entry cards (smart cards for identity verification, etc.), chip-based payment cards provided by banks, secure data storage and processing components, smart cards or eSIM chips on vehicles within C-V2X and V2X scope, certificates and keys in hardware security modules (HSM), Secure Elements (SE), Trusted Execution Environments (TEE) and the like, IoT devices and computers with security components (HSM, SE, TEE, etc.), mobile or IoT devices with software-based keys, computer applications, Digital Mobile Radio (DMR) transceivers, and structures like TEE cannot update their symmetric and asymmetric key pairs over a secure channel after the initialization phase.

In established key hierarchies, the root key at the top can be either a symmetric or asymmetric key. To prevent security vulnerabilities that may arise over time at the root key level, the solution is to supply users with new hardware (SIM/eSIM, identity card, payment card, access and authorization cards, IoT devices, etc.). In the known state of the art, symmetric and asymmetric keys cannot be updated remotely over secure platforms. This creates a risky situation, presenting an opening for ‘man-in-the-middle’ (MITM) attacks.

In the telecom sector, during the fabrication stage, SIM cards or eSIM chips are initialized with keys and certificates that allow verification by telecommunications network components, and then sent to telecom operators. The loaded keys are shared with the operator through secure methods like cargo or encrypted files and are registered in their systems. The keys and certificates for SIM cards and eSIM chips are loaded in a secure area via a contact interface during the fabrication stage. During loading, related sensitive data are also uploaded along with keys and certificates. This process is similarly applied for 3G, 4G, 5G, 6G, and beyond networks. When providing a phone number to the end user, the preloaded SIM card with keys and certificates is matched with data elements like IMSI (International Mobile Subscriber Identity) or ICCID (Integrated Circuit Card ID), and the card is delivered to the individual. For eSIM, profile loading is done by scanning a QR code using preloaded certificates. After the end user receives the profile for the SIM card or eSIM, the keys and uploaded certificates on the GSM application are not updated. For SIM cards, after a certain period, the expiry date of the loaded keys passes, necessitating the acquisition of a new card. For eSIM, as the validity period of the uploaded certificates expires, obtaining a new device or changing and re-initializing the chip is required. Current ETSI (European Telecommunications Standards Institute) and GSMA standards do not yet specify a method for remotely updating the aforementioned keys for SIM and eSIM. In current working reports, although there are suggestions to update the key with another previously loaded key, no solution has been shown regarding the update of the protecting key. In the field of telecommunications, card initialization can also be referred to as card programming or card personalization. During this stage, parameters like SMSP, ICCID, MCC (Mobile Country Code), MNC (Mobile Network Code), IMSI, K_i (Key), OP (Operator Code)/OPC (Operator Code Ciphered), ACC (Access Control Code), SQN (Sequence Number), SUCI (Subscription Concealed Identifier), HNET-PUBKEY (Home Network Public Key) can be loaded onto the card. In 5G networks, SUPI (Subscription Permanent Identifier), IMSI, and NAI (Network Access Identifier) are used as identity information. It is anticipated that similar data elements will be used in 6G and beyond networks. SUPI information is stored on UDM (Unified Data Management)/UDR (Unified Data Repository). In the network, to counteract IMSI catching attacks, SUPI is shared in the network as SUCI, encrypted with HNET-PUBKEY and ECIES (Elliptic Curve Integrated Encryption Scheme) by the UE (User Equipment). The relevant unit in the core network decrypts SUCI to create a 5G-GUTI (5G Globally Unique Temporary Identifier) and shares it with the UE containing SIM/eSIM. During subsequent authorizations, 5G-GUTI is used for a certain period and held on the AMF (Access and Mobility Management Function). Once its usage period expires, SUCI is again requested by the core network to repeat the process. Thus, the IMSI, which acts as the identity information of individuals in the network, is not circulated openly. Similarly, interaction between networks enables the use of 5G-GUTI with 4G-GUTI conversion.

The conversion from SUPI to SUCI is performed using asymmetric encryption, with the public key on the card and the private key in the network core. The public key encrypts SUPI to form SUCI, and the private key in the network core decrypts SUCI to retrieve SUPI.

SUPI, containing IMSI, is used to access keys on the card or chip, using UDM/UDR components of the core network (services related to HSS (Home Subscriber Server) in 4G networks) and is utilized in 5G-AKA (Authentication and Key Agreement) flows in 5G networks. These flows are defined by ETSI standards.

In WLANs, it uses EAP-AKA (Extensible Authentication Protocol-Authentication and Key Agreement) as well as EAP-TLS (Extensible Authentication Protocol-Transport Layer Security) algorithms in non-5G structures. EAP-AKA authenticates using EMSK (Extended Master Session Key) derived from Kᵢ on SIM/eSIM, while EAP-TLS uses an external EMSK. Kᵢ is not extracted directly from the card but is used to derive CK (Confidentiality Key) and IK (Integrity Key). Following 5G-AKA, EAP-AKA, and EAP-TLS flows, integrity control and encryption/privacy keys such as K_{rrc_enc}, K_{rrc_int}, K_{up_enc}, K_{up_int} are generated both on the UE and on AUSF/UDM/AMF, and data is transmitted encrypted with these keys.

In the key hierarchy, Kᵢ is a symmetric key and all security is built upon it. Kᵢ is stored on a file on the GSM card application (applet) and is written to the card via a physical interface after accessing the card with an administrator PIN. As mentioned here, the Kᵢ key and related authorization data, being symmetric keys, need to be renewed after a certain time. Since there is no previously shared key other than Kᵢ, and since key updates cannot be performed via SCP80 (Secure Channel Protocol 80) with OTA (Over-The-Air) interface, the process involves physically renewing the card. As the keys used for SCP80 are symmetric keys, they too need updating. Time-dependent vulnerabilities in SCP80 keys cause all keys transmitted via SCP80 to exhibit vulnerabilities. Therefore, this structure is not preferred in the current setup. Additionally, for the encrypted IMSI, SUCI, the source of the public key data must be trustworthy and resistant to MITM attacks, requiring loading via a physical interface and a secure channel in the current situation. Thus, securely updating keys is currently not feasible.

In the telecom sector, similar issues exist with SIM/eSIM used in telecoms and smart cards or eSIM chips on vehicles within the C-V2X scope, as well as certificates and keys on security hardware and software like SE or HSM. The same problem exists in digital signature-bearing smart cards/chips distributed on USB card readers or integrated SIM/eSIM, digital identity cards, passports, chip-based payment cards provided by banks, credit cards, technologies like HCE (Host Card Emulation) enabling contactless payments in a cloud-based structure, payment acceptance technologies like SoftPOS, POS, Mobile POS, OTP (one-time-password) systems, certificates in nodes for MSP in private blockchain networks, devices with security components like SE, IoT devices, computers, mobile or IoT devices with software-based keys, computer applications, TEE, and other elements using security hardware and software, and in OTP devices and software. If it is a smart card, the endpoint element is provided with a card application; if IoT device or computer, with a device firmware or special application, a secure channel is established between the specified endpoint device and the server, and the keys of this secure channel can be updated remotely. The secure channel operates independently of the payload it carries. Here, private keys and sensitive data can be transmitted.

In the known state of the art, as described in the United States patent document US20100042841A1, a system and method for securely updating encryption keys are discussed. An exchange protocol, such as a password-authenticated key exchange protocol, is used to create a shared secret key. From this shared secret key, two keys are generated: an operational key and a secret key. The operational key is used to encrypt messages between nodes. When it's time to change the operational key for security, the secret key is used to encrypt messages to create/distribute a new shared secret key. This process can be repeated any number of times to ensure security.

Also, in the known state of the art, United States patent document US20050144439A1 discusses a system and method for managing an encryption key that provides selective security services on data messages between wired/wireless terminals. In the developed method, there is a step for updating the encryption key upon its expiration, based on user choice.

Furthermore, in the United States patent document US20070140480A1, a key update system for a multi-tab network, a key management device, a communication terminal, and a key information generation method are discussed. Specifically, the invention relates to a technology for securely updating a key. The key management device in the key update system includes a key generation part that produces keys, a one-way value generation part with additional directional function, and each communication terminal includes a transmission section that transmits encrypted keys.

Existing key update methods in the known state of the art do not provide a secure channel and update keys are at risk. Therefore, due to the inability to securely update keys remotely in the current situation, there has been a need to develop a key update and revocation method that enables remote secure updating or revocation of private keys.

### Objective of the Invention

The objective of this invention is to realize a method for updating and revoking symmetric-asymmetric key groups, sensitive parameters, and data over a remote secure channel for security purposes.

### DETAILED DESCRIPTION OF THE INVENTION

To achieve the objective of this invention, the method for updating and revoking symmetric-asymmetric key groups, sensitive parameters, and data over a remote secure channel is illustrated in the attached figures.

These figures include.

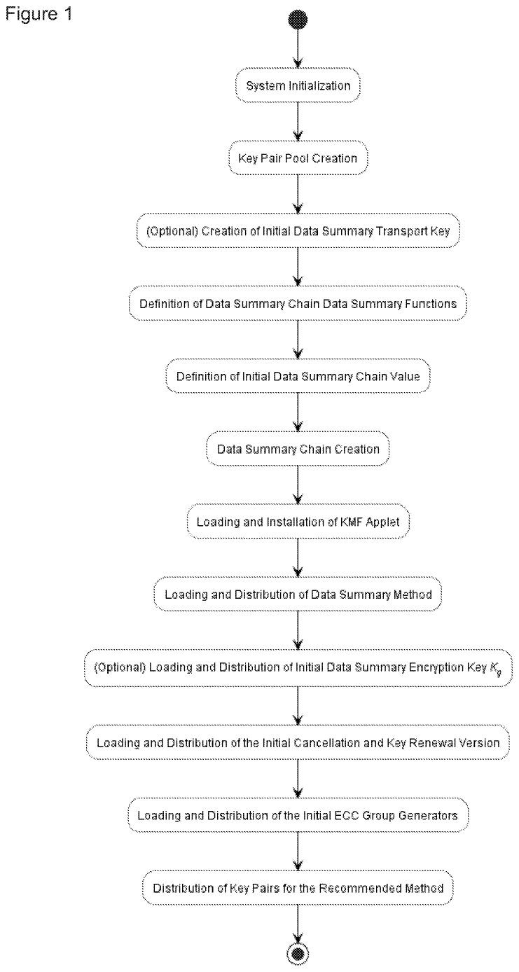

FIG. 1: A schematic view of the flow diagram related to the installation of the developed method's KMF server service and KMF endpoint client.

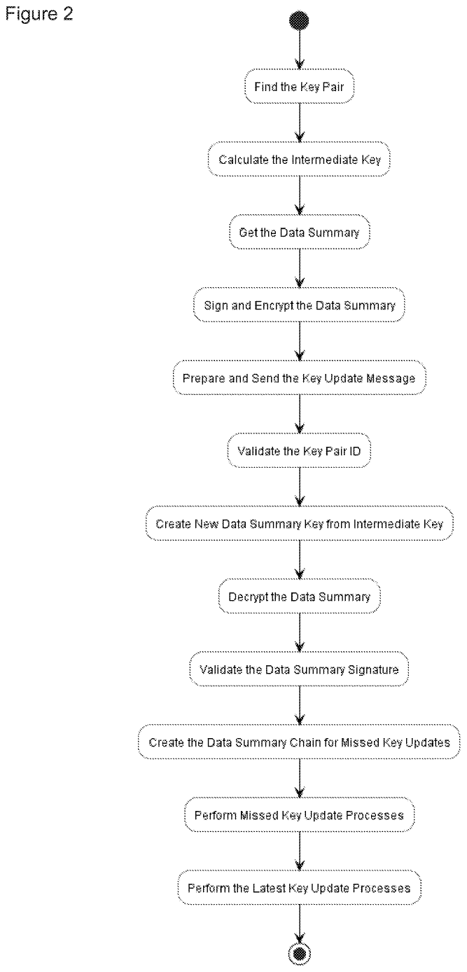

FIG. 2: A schematic view of the flow diagram related to the key renewal and revocation after the installation of the developed method's KMF server service and KMF endpoint client.

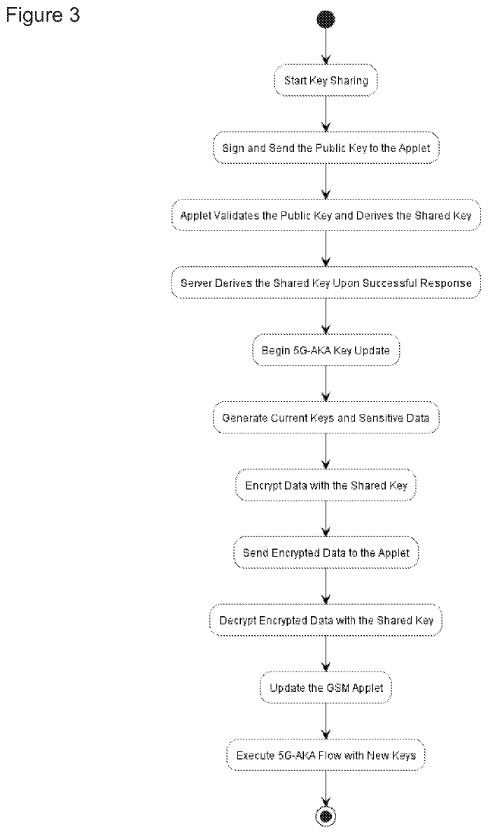

FIG. 3: A schematic view of the flow diagram related to key sharing and as an example application of the developed method, the key renewal and authorization stage for 5G-AKA in the telecommunications sector.

The abbreviations used are listed below:
K⁺: Public key pair
K⁻: Private key pair
rnd: Random number generating the key pair, used as a private key.
[symbol] : New random number generated because of the update.
K⁺ₜₑₘₚ: Temporary public key
K⁻ₜₑₘₚ: Temporary private key
K_{g}: Data digest carrying key.
Kᵢₘ: Temporary intermediate key
K_{g}: New data digest carrying key.
K_{msg}: Message data
\tilde{R}⁺: Updated public key pair.
\tilde{K}⁻: Updated private key pair.
P: ECC parameters for the public key
Q: ECC parameters for the private key
t_{1,2}: 1st and 2nd random numbers

$${t}_{1 , 2}^{- 1} :$$

Inverse or 1st and 2nd random numbers
V: Data digest set
v: Secret value initiating the data digest chain.
j: Size of the data digest chain
U_{P}: Public key list
U_{S}: Private key list

The method related to the remote update and revocation of developed keys involves:
Creating a pool of elliptic curve cryptography (ECC) based asymmetric key groups to be used for key sharing between the Key Management Function (KMF) endpoint client and KMF server service,
Generating the first data digest carrying key (K_{g}) using temporary private and public keys to update the created key pair,
Defining data digest functions and establishing the data digest chain by defining the initial data digest chain value in the KMF server service,
Loading parameters into the KMF endpoint client and distributing from the KMF server service the first data digest encryption key K_{g}, the initial version of key revocation and renewal, the first ECC group generators, key group data, parameters for concealment and integrity methods of message responses, parameters for whether the key revocation and renewal will be done in group or individually, and security indicators to the KMF endpoint client,
Performing the operation of creating a rekeying or revocation message in the KMF server service for the implementation of key renewal and revocation processes,
Processing the sensitive data encrypted by the KMF server service into the KMF application for the creation of rekeying or revocation message,
Conducting elliptic-curve Diffie-Hellman (ECDH) key sharing using the asymmetric key group and terminating the process with an error code if key sharing fails,
If the process is successful, continuing the normal processes of the structure where the KMF server service and endpoint client are established, completing the update of asymmetric keys owned by the KMF server service successfully,
Opening a secure communication channel by conducting key sharing between the KMF server service and the KMF endpoint client,
Sending keys and other sensitive data through this secure channel as desired by the structure on which the KMF platform is built.

These are the steps included in the process.

Step 1: In the developed method, initially, a pool of elliptic curve cryptography (ECC) based asymmetric key pairs is created for key sharing between the Key Management Function (KMF) endpoint client and the KMF server service. While forming the key pair pool, secret and public keys are obtained using a random number, and the random number along with the secret and public keys are collectively referred to as a group. These keys are used to open a secure channel between the central server and the endpoint element. The public and private key pairs [K⁺, K⁻] are obtained through Formulas 1, 2, and 3. The random number value [rnd] is kept together with the public and private key pairs [K⁺, K⁻].

$${F}_{gen . EKI} ( {rnd}_{i} ) = \{ {K}^{-} = {rnd}_{i} Q \vert {K}^{+} = {rnd}_{i}^{- 1} P \} \qquad ( Formula 1 )$$

$${rnd}_{i} = {F}_{RAND} ( . ) \qquad ( Formula 2 )$$

$${rnd}_{i}^{- 1} = {F}_{INVMOD} ( {rnd}_{i} , P . subGroupGen ) \qquad ( Formula 3 )$$

Optional Step 2: In the central server, using a random number, temporary private and public keys are generated along with the initial data digest carrying key (K_{g}). The random numbers to be used are selected as t₁=F_{RAND}(.) and t₂=F_{RAND}(.). Then, the inverse of the random number is calculated using Formula 4.

$${t}_{1}^{- 1} = {F}_{INVMOD} ( rnd , P . subGroupGen ) \qquad ( Formula 4 )$$

Using the inverses of the random numbers obtained through Formula 4, the temporary public key (K⁺ₜₑₘₚ) and temporary private keys (K⁻ₜₑₘₚ) are obtained via ECC scalar multiplication as per Formulas 5 and 6. (P represents the ECC parameters for the public key, and Q represents the ECC parameters for the private key.)

$${K}_{temp}^{+} = {t}_{1}^{- 1} P \qquad ( Formula 5 )$$

$${K}_{temp}^{-} = {t}_{1} Q \qquad ( Formula 6 )$$

The temporary public key (K⁺ₜₑₘₚ) obtained with Formula 5 is multiplied by the second random number to calculate a temporary intermediate key (Kᵢₘ) as per Formula 7.

$${K}_{im} = {t}_{2} {K}_{temp}^{+} \qquad ( Formula 7 )$$

Then, the temporary intermediate key (Kᵢₘ) obtained from Formula 7 and the temporary private key (K⁻ₜₑₘₚ) are scalar multiplied to create the initial data digest carrying key for the initialization process.

$${K}_{g} = {K}_{im} {K}_{temp}^{-} \qquad ( Formula 8 )$$

The data digest carrying key is used to transport encrypted data digest data that will be used to update the random number [rnd] and key pairs [K⁺, K⁻] obtained in step 1, from the KMF server service to the KMF endpoint client. The key group used to create the secure channel can be updated with this data digest. The key to protect the data digest is loaded during the initialization stage. This initial data digest carrying key will be shared with the KMF endpoint client and SIM/eSIM either during fabrication or through the Over The Air (OTA) interface. The recommended method for security reasons is during the fabrication stage.

Step 3: In the KMF server service, data digest functions are defined (Formula 9) and the initial value of the data digest chain is determined (Formula 10), thereby creating a data digest chain. The initial value of the data digest chain must be protected. The data digest, obtained through elliptic curve point multiplication, is used to update the random number and the set of public and private keys. The key set is updated both in the KMF endpoint client and the server service, ensuring both synchronization and renewal of the key set. This ensures the security of the keys used for secure communication. Additionally, the security of the keys transmitted over this secure communication channel is also ensured. When data digest chains are fully utilized, new lists are created, each with its own ID. The data digest chains are stored in a pool, and the identifier ID can be used in the sent message.

$$V = \{ {v}_{i} \vert 0 \leq i \leq j \} \qquad ( Formula 9 )$$

$${v}_{i} = h ( {v}_{i - 1} ) \qquad ( Formula 10 )$$

(V: data digest set, v: secret value initiating the data digest chain, j: size of the data digest chain)

The parameters created are used to initialize the KMF endpoint client and load parameters. The parameter loading must be done onto certificates located on the endpoint client's SIM/eSIM, USB reader integrated SIM/eSIM, digital signature-bearing smart cards, digital identity cards, chip-based payment cards provided by banks, smart cards or eSIM chips on vehicles within C-V2X. The loading onto the endpoint client can be done over OTA or during the fabrication stage. For security reasons, the recommended method is loading at the factory stage and programming the initial data onto the KMF endpoint client via a contact interface.

Step 4: Key update operations are performed over the secure communication channel opened by the KMF server service application. The secure communication channel is established between the KMF server service and the KMF endpoint client located at the endpoint. When a key update is needed for the KMF server service, it passes the relevant key or sensitive data and parameters to the KMF server service. The KMF server service then transfers these data to the KMF endpoint client over a secure channel. Since the KMF endpoint client is at the endpoint, it records or shares the incoming data to relevant points and securely completes the update.

Step 5: To implement key renewal and revocation operations, it is necessary to renew the asymmetric keys and session keys on the KMF server service and the KMF endpoint client. The expiration date of the session key is shorter than that of the asymmetric key pairs and is set according to the user's needs. The creation of the session key is done by using the asymmetric key groups located between the KMF endpoint client at the endpoint and the KMF server service in the center, and by creating a symmetric key through ECDH key sharing. When the asymmetric keys that create these session symmetric keys expire, a security vulnerability is created in the secure communication channel to be opened. Therefore, initially, the process of creating a rekeying or revocation message is carried out by the KMF service in the central server for updating these keys.

The key group to be updated [rnd, K⁺, K⁻] is located in the KMF server service database.

With each update, a new K_{g} key is created. For this purpose, a new random number is selected with Formula 11.

$$rnd = {F}_{RAND} ( . ) \qquad ( Formula 11 )$$

A temporary intermediate key, Kᵢₘ, is obtained by multiplying the temporary public key

$$( {K}_{temp}^{+} )$$

with the second random number.

$${K}_{im} = {rndK}_{temp}^{+} = \frac{rnd}{{k}_{temp}} P ∈ {𝔾}_{1} \qquad ( Formula 12 )$$

A new data digest carrying key is created by multiplying the temporary intermediate key (Kᵢₘ) and the temporary private key

$$( {K}_{temp}^{-} ) .$$

$${\tilde{K}}_{g} = {K}_{im} {K}_{temp}^{-} \qquad ( Formula 13 )$$

$$\begin{matrix}{\tilde{K}}_{g} = e ( {K}_{temp}^{-} , {K}_{im} ) = e ( {k}_{temp} Q , \frac{t}{{k}_{temp}} P ) = {e ( Q , P )}^{{k}_{temp} \frac{t}{{k}_{temp}}} \\ = {e ( Q , P )}^{t} ∈ {𝔾}_{2} , t ∈ {ℤ}_{q}^{*}\end{matrix} \qquad ( Formula 14 )$$

The last element according to the version number from the data digest chain vⱼ₋ᵥₑᵣ is taken and encrypted using AES (Advanced Encryption Standard) with \tilde{K}_{g}. Additionally, vⱼ₋ᵥₑᵣ is optionally signed with

$${K}_{temp}^{-}$$

for integrity check.

$${v}_{sign} = {F}_{sig . ECDSA} ( {v}_{j - ver} , {K}_{temp}^{-} ) \qquad ( Formula 15 )$$

$$en {c}_{{\tilde{K}}_{g}} ( {v}_{j - ver} ) = {F}_{enc . AES} ( {[ \tilde{{K}_{g}} \cdot x ]}^{128} , {v}_{j - ver} ) \qquad ( Formula 16 )$$

The encrypted data digest value, intermediate key value, version number, and key ID are created as data. Here, the key ID can be used as KCV (Key Check Value).

$${K}_{msg} = ( ver ‖ M ‖ {K}_{i m} ‖ {enc}_{{\tilde{K}}_{g}} ( {v}_{j - ver} ) ‖ {v}_{sign} ) \qquad ( Formula 17 )$$

The KMF service sends this message in a manner suitable for the platform it is used on, such as SMPP/UCP-EMI or CAT-TP for telecom, or TCP or with their communication capability; in payment, digital signature, V2X, IoT domains, it sends via TCP or with their communication capability to the KMF endpoint client. The KMF endpoint client decrypts the incoming message with its key and updates the key set used for secure communication on it. The key update process for the KMF secure channel creation key can be done automatically at certain intervals or can be triggered by the central server it is connected to.

Step 6: After the session key's lifespan between the KMF central server service and the endpoint KMF client expires, a new ECDH key sharing is performed when it is time to update asymmetric and symmetric keys, sensitive data, parameters, and certificates used in their own systems at the endpoint in the next used infrastructure (such as telecom, payment systems, digital signature, access and authorization, OTP verification, vehicle-to-vehicle communication, IoT, etc.). These asymmetric-symmetric keys, sensitive data, and parameters are encrypted over the session key by the KMF server service and shared with the platform, which then sends the encrypted data to the endpoint KMF client using the appropriate communication protocol used by the platform. At this point, the KMF server service can also communicate directly with the KMF client, depending entirely on the interface that can be integrated into the system. The aim is to transfer the sensitive data encrypted by the KMF server service to the KMF client application.

The message created is sent to the KMF endpoint client on the SIM/eSIM via fragmented APDU commands with SCP80 encryption as an OTA message via SMS or CAT-TP. Other protocols can also be used; it is a protocol-independent model.

The commands reaching the KMF endpoint client are processed, first calculating the new K_{g}, Kᵢₘ, and temporary private key

$$( {K}_{temp}^{-} ) .$$

$$\begin{matrix}{\tilde{K}}_{g} = e ( {K}_{temp}^{-} , {K}_{i m} ) \\ = e ( {k}_{temp} Q , \frac{t}{{k}_{temp}} P ) \\ = {e ( Q , P )}^{{k}_{temp} \frac{t}{{k}_{temp}}} \\ = {e ( Q , P )}^{t} ∈ {𝔾}_{2} , t ∈ {ℤ}_{q}^{*}\end{matrix} \qquad ( Formula 18 )$$

$${\tilde{K}}_{g} = {K}_{i m} {K}_{temp}^{-} \qquad ( Formula 19 )$$

The calculated \tilde{K}_{g} is used to decrypt enc_{\tilde{K}}_{_{g}}(vⱼ₋ᵥₑᵣ) to obtain vⱼ₋ᵥₑᵣ.

$${v}_{j - ver} = {F}_{dec . AES} ( {[ {\tilde{K}}_{g} \cdot x ]}^{128} , {enc}_{{\tilde{K}}_{g}} ( {v}_{j - ver} ) ) \qquad ( Formula 20 )$$

The signature is verified using F_{val.ECDSA}(vⱼ₋ᵥₑᵣ, v_{sign},

$${K}_{temp}^{+} )$$

for data digest key update. The incoming key update version is compared with the registered key update version, and if any key updates are missed, the data digest values are calculated one by one for the future and multiplied by the current key pair, cyclically updating the keys.

$$\text{?} = {v}_{j - {ver}_{missed}} rnd \% P \qquad ( Formula AA )$$

$${\tilde{K}}^{-} = {v}_{j - {ver}_{missed}} {K}^{-} \qquad ( Formula 21 )$$

$${\tilde{K}}^{+} = ( \frac{1}{{v}_{j - {ver}_{missed}}} ) {K}^{+} \qquad ( Formula 22 )$$

After completing this process for all past key renewals, the keys are updated for the most recent value received.

$${\tilde{K}}^{-} = {v}_{j - ver} {K}^{-} \qquad ( Formula 23 )$$

$${\tilde{K}}^{+} = ( \frac{1}{{v}_{j - ver}} ) {K}^{+} \qquad ( Formula 24 )$$

Step 7: The successful completion of updating the asymmetric keys owned by the KMF Service and the creation of a session key with this key to perform key sharing between the KMF server service and the KMF endpoint client opens a secure communication channel. From this point onwards, the structure on which the KMF platform is built can send its keys and other sensitive data over this secure channel as desired. In telecom applications, expired SIM/eSIM keys and sensitive data are sent encrypted to the KMF client over this channel, enabling the KMF client on the SIM/eSIM to directly update the keys. A similar flow is used for chip cards in payment systems. The KMF client is in the form of a card application for smart cards. Depending on the used endpoint device, the KMF client can be in the form of computer software or hardware firmware.

Step 8: After successfully completing the update of sensitive data, certificates, and keys through the KMF service, system components continue their normal processes, such as performing the 5G-AKA flow in telecom specifically for 5G (includes 3G/4G/5G/6G and beyond processes), executing EMV payment transactions in payment systems (ARQC/ARPC verification, SDA, CDA, DDA verification, etc.), validation and signing in digital signature processes, logging in and secure data sharing in IoT and C-V2X/V2X services, and completing OTP verification processes.

The developed method includes the eight steps mentioned above. The communication channel (wired (Ethernet, Serial port, CAN, I2C, etc.), wireless (Wi-Fi, Li-Fi, Bluetooth, DMR (Digital Mobile Radio), QR, IR, etc.)) and protocol (TCP, CAT-TP, SMPP, etc.) are operated completely insecurely.

More specifically, the developed encryption update and cancellation method;

### During the Setup Phase:

In the setup phase, the elliptic curve parameters (such as secp256k1, etc.) used for the Key Management Function (KMF) server service and the KMF endpoint client's initial parameters are arranged and shared.
In the setup phase, functions for the data digest function (such as SHA-256 or SHA-512, etc.) are determined and used.
In the first stage of the setup phase, a pool of random numbers generating elliptic curve cryptography (ECC) based asymmetric key pairs (Uₚ, Uₛ) is created for key sharing between the KMF endpoint client and the KMF server service using Formulas 1 and 2.
(The key pairs [K⁺, K⁻] are generated through ECC scalar multiplication as in Formulas 1, 2, and 3 using the F_{gen.EKI}(rnd) function. The RAND function returns an integer. P and Q are subgroup generators.)

$${F}_{gen . EKI} ( {rnd}_{i} ) = \{ {K}^{-} = {rnd}_{i} Q \vert {K}^{+} = {rnd}_{i}^{- 1} P \} \qquad ( Formula 1 )$$

$$rn {d}_{i} = {F}_{RAND} ( \cdot ) \qquad ( Formula 2 )$$

$${rnd}_{i}^{- 1} = {F}_{INVMOD} ( {rnd}_{i} , P . subGroupGen ) \qquad ( Formula 3 )$$

Registering the determined number of created key pairs and the KMF server service's database.
In the second stage of the setup phase for creating the initial data digest carrying key, two random numbers are selected as t₁=F_{RAND}(.) and t₂=F_{RAND}(.)

Calculating the inverse of the two selected random numbers using Formula 4

$${t}_{1}^{- 1} = {F}_{INVMOD} ( rnd , P . subGroupGen ) \qquad ( Formula 4 )$$

Calculating temporary public and private keys as in Formulas 5 and 6 using the selected random number and its inverse (ECC scalar multiplication),

$${K}_{temp}^{+} = {t}_{1}^{- 1} P \qquad ( Formula 5 )$$

$${K}_{temp}^{-} = {t}_{1} Q \qquad ( Formula 6 )$$

Calculating the temporary intermediate key (Kᵢₘ) using the obtained temporary public key and the second random number as in Formula 7 (ECC scalar multiplication),

$${K}_{i m} = {t}_{2} {K}_{temp}^{+} \qquad ( Formula 7 )$$

Creating the initial data digest carrying key by multiplying the obtained temporary intermediate key with the temporary private key as in Formula 8 (ECC point multiplication),

$${K}_{g} = {K}_{i m} {K}_{temp}^{-} \qquad ( Formula 8 )$$

In the next stage, while creating K_{g}, selecting t₁ randomly and creating t₂ from the data digest chain,
Determining the data digest function to be used according to user preference and the capabilities of the devices at the endpoint, resetting the key renewal index, defining methods for encrypting and integrity checking of message responses, choosing whether the keys will be loaded individually or in groups, and selecting parameters for individual or group revocations accordingly,

Creating a data digest chain in the form of a chain by selecting a random or predefined value, calculating its data digest value using Formula 9, and then calculating the data digest value of the calculated value using Formula 9,

$$V = \{ {v}_{i} \vert 0 \leq i \leq j \} \qquad ( Formula 9 )$$

$${v}_{i} = h ( {v}_{i - 1} ) \qquad ( Formula 10 )$$

Initially sharing the data digest function to be used with the KMF endpoint client by the KMF server service,

### In the Key Renewal and Revocation Phase:

During the key renewal and revocation process phase, the key pair [K_{M}⁺, K_{M}⁻] to be updated is found in the KMF server service database with

$${K}_{temp}^{+} = {k}_{i} Q and {K}_{temp}^{-} = {k}_{i}^{- 1} P .$$

A random number is selected as per Formula 11,

$$rnd = {F}_{RAND} ( . ) \qquad ( Formula 11 )$$

The intermediate key Kᵢₘ is calculated by multiplying the temporary public key with the second random number as per Formula 12,

$${K}_{im} = rnd {K}_{temp}^{+} = \frac{rnd}{{k}_{temp}} P ∈ {𝔾}_{1} \qquad ( Formula 12 )$$

The new data digest carrying key is created by multiplying the obtained intermediate key and the private key as in Formulas 13 and 14,

$${\tilde{K}}_{g} = {K}_{im} {K}_{temp}^{-} \qquad ( Formula 13 )$$

$$\begin{matrix}{\tilde{K}}_{g} = e ( {K}_{temp}^{-} , {K}_{im} ) \\ = e ( {k}_{temp} Q , \frac{t}{{k}_{temp}} P ) \\ = {e ( Q , P )}^{{k}_{temp} \frac{t}{{k}_{temp}}} \\ = {e ( Q , P )}^{t} ∈ {𝔾}_{2} , t ∈ {ℤ}_{q}^{*}\end{matrix} \qquad ( Formula 14 )$$

Encrypting the last element vⱼ₋ᵥₑᵣ from the data digest chain with \tilde{K}_{g} using the Advanced Encryption Standard (AES) encryption technique,

$${v}_{sign} = {F}_{sig . ECDSA} ( {v}_{j - ver} , {K}_{temp}^{-} ) \qquad ( Formula 15 )$$

$${enc}_{{\tilde{K}}_{g}} ( {v}_{j - ver} ) = {F}_{enc . AES} ( {[ \text{?} \cdot x ]}^{128} , {v}_{j - ver} ) \qquad ( Formula 16 )$$

Creating data using Formula 17 with the encrypted data digest value, the intermediate key value, version number, and key ID,

$${K}_{msg} = ( ver ‖ M ‖ {K}_{im} ‖ {enc}_{{\tilde{K}}_{g}} ( {v}_{j - ver} ) ‖ {v}_{sign} ) \qquad ( Formula 17 )$$

Sending the created message to the KMF endpoint client application independently of the communication channel,

Processing the commands/messages received by the KMF endpoint client, first calculating the new \tilde{K}_{g} as per Formulas 18 and 19 using Kᵢₘ and the private key

$$( {K}_{temp}^{-} ) ,$$

$$\begin{matrix}{\tilde{K}}_{g} = e ( {K}_{temp}^{-} , {K}_{im} ) \\ = e ( {k}_{temp} Q , \frac{t}{{k}_{temp}} P ) \\ = {e ( Q , P )}^{{k}_{temp} \frac{t}{{k}_{temp}}} \\ = {e ( Q , P )}^{t} ∈ {𝔾}_{2} , t ∈ {ℤ}_{q}^{*}\end{matrix} \qquad ( Formula 18 )$$

$${\tilde{K}}_{g} = {K}_{im} {K}_{temp}^{-} \qquad ( Formula 19 )$$

Decrypting enc_{\tilde{K}}_{_{g}}(vⱼ₋ᵥₑᵣ) with the calculated \tilde{K}_{g} to obtain vⱼ₋ᵥₑᵣ as per Formula 20,

$${v}_{j - ver} = {F}_{dec . AES} ( {[ {\tilde{K}}_{g} \cdot x ]}^{128} , {enc}_{{\tilde{K}}_{g}} ( {v}_{j - ver} ) ) \qquad ( Formula 20 )$$

If there are missed key updates, comparing the incoming key update version with the registered key update version, and then calculating future data digest values one by one as per Formulas CC, 21, and 22, multiplying them with the current key pair, and updating the keys and random number,

$$\text{?} = {v}_{j - {ver}_{missed}} rnd \% P \qquad ( Formula CC )$$

$${\tilde{K}}^{-} = {v}_{j - {ver}_{missed}} {K}^{-} \qquad ( Formula 21 )$$

$${\tilde{K}}^{+} = ( \frac{1}{{v}_{j - {ver}_{missed}}} ) {K}^{+} \qquad ( Formula 22 )$$

After completing all past key renewals, updating the keys for the most recent value received,

$$\text{?} = {v}_{j - ver} rnd \% P \qquad ( Formula DD )$$

$${\tilde{K}}^{-} = {v}_{j - ver} {K}^{-} \qquad ( Formula 23 )$$

$${\tilde{K}}^{+} = ( \frac{1}{{v}_{j - ver}} ) {K}^{+} \qquad ( Formula 24 )$$

Performing elliptic-curve Diffie-Hellman (ECDH) key sharing using the same asymmetric key group [rnd, K⁺, K⁻] owned by the KMF server service and the KMF endpoint client application,
Calculating the shared key on the KMF endpoint client application and sending the success code to the KMF server service,
If successful, the KMF server service calculates the symmetric key on its side and completes key sharing with the KMF endpoint client application mutually,
If the process fails, sending an error code and terminating the process,

If the process is successful, the KMF server service and the endpoint client's established structure continue their normal processes.

These are the steps included in the process.

After the key update process is successfully completed, the structure on which the KMF platform is built continues its normal processes with its own keys and sensitive data. In telecom applications, the GSM card application can log into the KMF server service, applications required for digital signatures perform signing processes, applications for authorization and access can verify users, and C-V2X/V2X applications share their data securely with each other. Payment applications create and verify payment-related cryptograms, and OTP systems can continue to generate offline OTPs. IoT or mobile devices can continue their secure operations.

As mentioned above, the developed method consists of three phases. The first phase is the setup phase of the method. In this phase, the initial parameters of the KMF server service and the KMF endpoint client are arranged and shared. The first step in the first phase involves the KMF server service selecting the elliptic curve parameters (such as P, Q∈ [symbol] 1) and the data digest function. The recommended elliptic curve parameters for the developed method are secp256k, but this is not mandatory. SHA-256 and SHA-512 functions are used for the data digest function, but more effective methods can be substituted if available. ECC-based asymmetric key pairs U_{P} (public key list) and Uₛ (private key list) for key sharing between the KMF endpoint client and the KMF server service are created. The size of the pool is set to be more than the number of KMF endpoint clients owned. Multiple ECC key pairs can be loaded onto a KMF endpoint client. The key pairs [K⁺, K⁻]=F_{gen.EKI}(rnd) are created using Formulas 1, 2, and 3. A determined number of key pairs can be created, and the used random number is registered in the KMF server service's database as a group. This pool can be expanded as needed. The K_{g} key that carries the data digest data used to update the key pair is created from the KMF server service to the KMF endpoint client. When creating K_{g}, t₁=F_{RAND}(.) will be randomly selected, and t₂ will be taken from the data digest chain. The inverse of the first number (t₁) is calculated. Then temporary public and private keys are calculated. The temporary public key is multiplied with the second number (t₂) to calculate the temporary intermediate key. The temporary intermediate key and temporary private key are scalar multiplied to create the initial data digest carrying key for the initialization process. This key is created to encrypt the data digest during the key update and revocation process. This key is shared with the KMF endpoint client via SIM/eSIM fabrication or OTA interface. The recommended method for security reasons is the fabrication stage. In the next stage, when creating K_{g}, t₁ will be randomly selected, and t₂ will be taken from the data digest chain. The next step is determining the data digest function to be used and resetting the key renewal index. SHA-256 and SHA-512 can be selected for the data digest function, or new methods can be used if they emerge. It will be chosen according to the user's preference and the capabilities of the devices at the KMF endpoint. A random or predefined data is selected, then the data digest value of this selected data and the data digest value of the calculated value are calculated, and a chain-like data digest chain is created. Additionally, since a new chain will be needed when the chain is used and exhausted, the chains are stored in a pool. Multiple chains can be created and stored. The data digest chain is used for key updates, starting from the end of the chain. Due to the difficulty in reversing the data digests, they are used for security purposes. The KMF endpoint client is initialized with the created parameters, and parameter loading is performed. For parameter loading, the endpoint client needs to be loaded onto SIM/eSIM cards. The KMF endpoint client loading can be done via OTA (Over-The-Air) or during the fabrication stage. The recommended method for security reasons is to load the endpoint client during the fabrication stage and program the initial data onto the KMF endpoint client's contact interface. With the KMF endpoint client, the data digest function to be used is shared parametrically first. Parameters related to how protection will be provided in the responses of the messages, the initially created K_{g} key is loaded, and version numbers related to key renewal are reset and loaded. The selected ECC parameters are also loaded onto the KMF endpoint client. The recommended ECC parameters are secp256k, but they can be changed. In the next step, the recommended number of key pairs [K⁺, K⁻] is loaded onto the card. The loaded element (SIM/eSIM) is also associated on the KMF server service side.

The second phase of the developed method is the implementation of key renewal and revocation processes for the KMF server service and the KMF endpoint service. Operations can be carried out for a certain period with the existing parameters. For security reasons, it is recommended to update after the initial use of the SIM/eSIM. First, the key pair [K⁺, K⁻] to be updated is found in the KMF server service database. As shown below, a new K_{g} key is created, followed by the selection of a random number. An intermediate key Kᵢₘ is calculated by multiplying the temporary public key with the second random number. Then, the intermediate key and the private key are multiplied to create a new data digest transport key. The last element vⱼ₋ᵥₑᵣ from the data digest chain is taken and encrypted with \tilde{K}_{g} using AES encryption. Additionally, vⱼ₋ᵥₑᵣ is optionally signed with Ktemp− for integrity control. The encrypted data digest value, the intermediate key value, the version number, and the key ID are created as data. The generated message is sent to the KMF endpoint client on the SIM/eSIM via fragmented APDU commands with SCP80 encryption as an OTA message via SMS or CAT-TP. The commands received by the KMF endpoint client are processed, first calculating the new \tilde{K}_{g}, Kᵢₘ, and the private key (Kₜₑₘₚ⁻). The calculated \tilde{K}_{g} is used to decrypt enC_{\tilde{K}g}(vⱼ₋ᵥₑᵣ) and reveal vⱼ₋ᵥₑᵣ.

The signature is verified using F_{val.ECDSA}(vⱼ₋ᵥₑᵣ, v_{sign}, Kₜₑₘₚ⁺) for data digest key update. If there are any missed key updates, the incoming key update version is compared with the registered key update version, and future data digest values are calculated one by one, multiplied with the current key pair, and the keys are updated. This process is completed for all past key renewals, and then the keys are updated for the most recent value received.

The third phase of the developed method is the key sharing and 5G-AKA key renewal and authorization stage. After a certain time, it becomes necessary to update the keys required for 5G-AKA. Normally, new SIM/eSIM procurement would be required for the update process. However, thanks to the developed method, this is no longer necessary. In this flow, initially, ECDH key sharing is performed using the same asymmetric key group [K⁺, K⁻, rnd] owned by the KMF server service and the KMF endpoint client. For key sharing, the KMF service signs the private key (rnd), the public key (K⁺), and the private key (K⁻) with ECDSA and sends the public key and signature to the KMF endpoint client via OTA with SCP80 encryption. The KMF endpoint client first checks the signature of the received public key (K⁺), protecting the data source against MITM attacks, and after verification, calculates the shared key and sends the success code to the KMF server service. After receiving the success code, the KMF server service calculates the symmetric key on its side and completes the key sharing with the KMF endpoint client application mutually, and if the signature fails, it sends an error code and terminates the process. Key sharing needs to be repeated after a certain time. If a long time passes, the asymmetric keys used in key sharing will need to be updated. While the key sharing is valid, when it is necessary to update the keys used for 5G-AKA, the KMF server service first generates new keys and necessary sensitive data (Ki, OP, RAND, SQN, etc.) on the UDM.

The KMF server service encrypts the generated data using AES with the shared key Kₛ and sends the encrypted data to the KMF endpoint client via OTA with SCP80 encryption. The KMF endpoint client decrypts the encrypted data with its own K_s and performs integrity checks. Subsequently, if necessary, it logs into the interface provided by the GSM application and updates the necessary data. If the process is successful, a success code is transmitted to the KMF server service and the process is completed. If a failure code is sent to the KMF server service, the process is reversed and retried. In the update of the GSM application, the keys on the UDM are updated with the keys on the GSM application, and the current system continues to operate without any disruption. In this way, the KMF endpoint client updates the GSM application, and the KMF server service updates the UDM database, ensuring that there is no interference in the flows of the current system components and extending the lifespan of the SIM/eSIM products.

The developed key sharing creation, update, or revocation flows can similarly solve similar key update problems using a similar KMF endpoint client and KMF server service in structures like C-V2X/V2X that use SIM/eSIM in the telecom sector, payment cards used in the financial technology sector, HCE (Host Card Emulation) technology that enables contactless payment in a cloud-based structure, SoftPOS, SAM cards in mobile POS devices, or equivalent secure software and hardware data storage processing units, OTP systems, certificates in nodes for MSP (Membership Service Provider) in private blockchain networks, HSM solutions using smart cards, digital signatures (mobile signature, USB token, smart card, OTP systems), identity cards, passports, access systems, OTP systems, and certificates in nodes for updating purposes in private blockchain networks.

The developed system can be implemented with any type of algorithm, SIM card, or on different platforms.

The advantages obtained with the developed key renewal and revocation method are listed below:
Enables remote updating of asymmetric and symmetric keys.
Without interfering with the existing system components' workflows, it extends the lifespan of SIM/eSIM products or any software and hardware elements that have a lifespan dependent on key renewal.
Updating master keys is expected to have minimal impact on other structures used in the field within the key hierarchy. That is, the method can be applied without making changes to the existing structure.
With variable lengths and pools of data digest chains, it allows frequent key updates and complicates predictability for post-quantum crypto operations through dynamic version number transmission.
Prevents the formation of time-dependent vulnerabilities for certificates in SIM/eSIM-connected devices in the field.
Offers a solution to the need for remote update of keys enabling remote operations on devices, especially important during chip crises and for extending the lifespan of existing SIM/eSIM and IoT technologies.

Telecom companies can integrate this solution into their operations at a suitable integration cost, potentially reducing annual SIM card expenses.
In the payment sector, it can extend the lifespan of payment cards and enhance the security of mobile devices.
Allows remote updating or revocation of keys in security components (HSM, SE, TEE) or software-based protection modules like Whitebox Crypto.

Addresses security vulnerabilities in solutions like C-V2X/V2X by enabling remote key management in distant locations.
Enhances remote lifespan extension for identity cards and digital signatures.
Enables remote key management for smart card-using HSM solutions.

Facilitates security enhancements in endpoint devices like IoT devices, payment devices, identity access devices, end-user mobile devices, computers, OTP devices, etc.

1. The invention relates to a method for updating keys remotely, the method comprising:
creating a pool of asymmetric key pairs based on elliptic curve cryptography (ECC) for key sharing between a Key Management Function (KMF) endpoint client and a KMF server service,
$${F}_{gen . EKI} ( {rnd}_{i} ) = \{ {K}^{-} = {rnd}_{i} Q \vert {K}^{+} = {rnd}_{i}^{- 1} P \} \qquad ( Formula 1 )$$
$${rnd}_{i} = {F}_{RAND} ( . ) \qquad ( Formula 2 )$$
$${rnd}_{i}^{- 1} = {F}_{INVMOD} ( {rnd}_{i} , P . subGroupGen ) \qquad ( Formula 3 )$$
creating a first key transport hash (K_{g}) by the process steps,
registering the determined number of created key pairs in the KMF server service's database,
in the second phase of the setup, selecting two random numbers t₁=F_{RAND}(.) and t₂=F_{RAND}(.) for creating the initial data summary transport key,
calculating the inverse of the two selected random numbers using Formula 4,
$${t}_{1}^{- 1} = {F}_{INVMOD} ( rnd , P . subGroupGen ) \qquad ( Formula 4 )$$
using the selected random number and its inverse to calculate temporary public and private keys as per Formulas 5 and 6, utilizing ECC scalar multiplication,
$${K}_{temp}^{+} = {t}_{1}^{- 1} P \qquad ( Formula 5 )$$
$${K}_{temp}^{-} = {t}_{1} Q \qquad ( Formula 6 )$$
calculating the temporary intermediate key (Kᵢₘ) using Formula 7, by multiplying the obtained temporary public key with the second random number, using ECC scalar multiplication,
$${K}_{im} = {t}_{2} {K}_{temp}^{+} \qquad ( Formula 7 )$$
creating the initial data summary transport key by multiplying the obtained temporary intermediate key with the temporary secret key as in Formula 8, using ECC point multiplication
$${K}_{g} = {K}_{im} {K}_{temp}^{-} \qquad ( Formula 8 )$$
in order to update the generated key pair,
defining hash functions and creating a hash chain in the KMF server service,
loading parameters into the KMF endpoint client and distributing the initial cancelation and key update version, initial ECC group generators, and key pair data from the KMF server service to the KMF endpoint client,
creating a re-keying or cancel message by the process steps,
identifying the keys to be updated, [K⁺ₜₑₘₚ, K⁻ₜₑₘₚ], from the KMF server service database with K⁻ₜₑₘₚ=kₜₑₘₚQ and K⁻ₜₑₘₚ=kₜₑₘₚ⁻¹P,
selecting a random number as per Formula 11,
$$rnd = {F}_{RAND} ( . ) \qquad ( Formula 11 )$$
calculating the interim key Kᵢₘ by multiplying the temporary public key with the second random number as per Formula 12,
$${K}_{i m} = {rndK}_{temp}^{+} \frac{rnd}{{k}_{temp}} P ∈ {𝔾}_{1} \qquad ( Formula 12 )$$
creating a new data summary transport key by multiplying the interim key with the private key as per Formulas 13 and 14,
$${\tilde{K}}_{g} = {K}_{i m} {K}_{temp}^{-} \qquad ( Formula 13 )$$
$$\begin{matrix}{\tilde{K}}_{g} = e ( {K}_{temp}^{-} , {K}_{i m} ) \\ = e ( {k}_{temp} Q , \frac{t}{{k}_{temp}} P ) \\ = {e ( Q , P )}^{{k}_{temp} \frac{t}{{k}_{temp}}} \\ = e {( Q , P )}^{t} ∈ {𝔾}_{2} , t ∈ {ℤ}_{q}^{*}\end{matrix} \qquad ( Formula 14 )$$
taking the last element vⱼ₋ᵥₑᵣ according to the version number from the data summary chain and encrypting \tilde{K}_{g} with the Advanced Encryption Standard (AES) encryption technique,
$${v}_{sign} = {F}_{sig . ECDSA} ( {v}_{j - ver} , {K}_{temp}^{-} ) \qquad ( Formula 15 )$$
$${enc}_{{\tilde{K}}_{g}} ( {v}_{j - ver} ) = {F}_{enc . AES} ( {[ {\tilde{K}}_{g} \cdot x ]}^{128} , {v}_{j - ver} ) \qquad ( Formula 16 )$$
creating the encrypted data summary value, the intermediate key value, the version number, and the key ID as data using Formula 17,
$${K}_{msg} = ( ver ‖ M ‖ {K}_{i m} ‖ {enc}_{{\tilde{K}}_{g}} ( {v}_{j - ver} ) ‖ {v}_{sign} ) \qquad ( Formula 17 )$$
sending the obtained message to the KMF endpoint client application independently of the communication channel
in order to perform key update and cancel operations in the KMF server service, processing sensitive data encrypted by the KMF server service in the KMF application for the re-keying or cancel message creation process,
executing elliptic-curve Diffie-Hellman (ECDH) key sharing using the asymmetric key group, and terminating the process with an error code if key sharing fails,
continuing normal processes for both the KMF server service and endpoint client if the operation is successful.

2. (canceled)

3. The invention, according to claim 1, relates to a method for updating keys remotely; characterized by comprising the steps in the phase of defining data summary functions and creating a data summary chain in the KMF server service,
determining the data summary function to be used according to user preference and the capabilities of the devices at the endpoint and resetting the key update index,
selecting a random or predefined data, calculating its data summary value using Formula 9, and then calculating the data summary value of the calculated value using Formula 10 to create a data summary chain in the form of a chain.
$$V = \{ {v}_{i} \vert 0 \leq i \leq j \} \qquad ( Formula 9 )$$
$${v}_{i} = h ( {v}_{i - 1} ) \qquad ( Formula 10 )$$

4. (canceled)

5. The invention relates to a method for updating keys remotely according to claim 1; characterized by comprising the steps in the process step of processing the sensitive data encrypted by the KMF server service to the KMF application for the operation of creating a re-keying or cancellation message,
commands/messages reaching the KMF endpoint client are processed, and firstly the new \tilde{K}_{g} is calculated using Kᵢₘ and the secret key
$$( {K}_{temp}^{-} )$$
as described in Formulas 18 and 19,
$$\begin{matrix}{\tilde{K}}_{g} = e ( {K}_{temp}^{-} , {K}_{i m} ) \\ = e ( {k}_{temp} Q , \frac{t}{{k}_{temp}} P ) \\ = {e ( Q , P )}^{{k}_{temp} \frac{t}{{k}_{temp}}} \\ = e {( Q , P )}^{t} ∈ {𝔾}_{2} , t ∈ {ℤ}_{q}^{*}\end{matrix} \qquad ( Formula 18 )$$
$${\tilde{K}}_{g} = {K}_{i m} {K}_{temp}^{-} \qquad ( Formula 19 )$$
decoding enc_{\tilde{K}}_{_{g}}(vⱼ₋ᵥₑᵣ) with the calculated \tilde{K}_{g} and calculating vⱼ₋ᵥₑᵣ using Formula 20,
$${v}_{j - ver} = {F}_{dec . AES} ( {[ {\tilde{K}}_{g} \cdot x ]}^{128} , {enc}_{{\tilde{K}}_{g}} ( {v}_{j - ver} ) ) \qquad ( Formula 20 )$$
comparing the incoming key update version with the registered key update version and, if there are missed key updates, calculating the forward data summary values individually in a cyclic manner as in Formula EE, Formulas 21 and 22, multiplying them with the current key pair, and updating the keys,
$$\text{?} = {v}_{j - {ver}_{missed}} rnd \% P \qquad ( Formula EE )$$
$${\tilde{K}}^{-} = {v}_{j - {ver}_{m issed}} {K}^{-} \qquad ( Formula 21 )$$
$${\tilde{K}}^{+} = ( \frac{1}{{v}_{j - {ver}_{missed}}} ) {K}^{+} \qquad ( Formula 22 )$$
after completing all past key renewals, updating the keys for the most recently received value as well,
$$\text{?} = {v}_{j - ver} rnd \% P \qquad ( Formula FF )$$
$${\tilde{K}}^{-} = {v}_{j - ver} {K}^{-} \qquad ( Formula 23 )$$
$${\tilde{K}}^{+} = ( \frac{1}{{v}_{j - ver}} ) {K}^{+} \qquad ( Formula 24 )$$
performing elliptic-curve Diffie-Hellman (ECDH) key exchange using the same asymmetric key group [rnd, K⁺, K⁻] that the KMF server service and the KMF endpoint client application have,
calculating the shared key on the KMF endpoint client application and sending the success code to the KMF server service,
with the success code, the KMF server service calculates the symmetric key on its side and completes the key exchange mutually with the KMF endpoint client application.

6. The invention relates to a method for updating keys remotely according to claim 3; characterized by comprising the steps in the process step of processing the sensitive data encrypted by the KMF server service to the KMF application for the operation of creating a re-keying or cancellation message,
commands/messages reaching the KMF endpoint client are processed, and firstly the new \tilde{K}_{g} is calculated using Kᵢₘ and the secret key
$$( {K}_{temp}^{=} )$$
as described in Formulas 18 and 19,
$$\begin{matrix}{\tilde{K}}_{g} = e ( {K}_{temp}^{-} , {K}_{i m} ) \\ = e ( {k}_{temp} Q , \frac{t}{{k}_{temp}} P ) \\ = {e ( Q , P )}^{{k}_{temp} \frac{t}{{k}_{temp}}} \\ = e {( Q , P )}^{t} ∈ {G}_{2} , t ∈ {Z}_{q}^{*}\end{matrix} \qquad ( Formula 18 )$$
$${\tilde{K}}_{g} = {K}_{i m} {K}_{temp}^{-} \qquad ( Formula 19 )$$
decoding enc_{\tilde{K}g}(vⱼ₋ᵥₑᵣ) with the calculated \tilde{K}_{g} and calculating vⱼ₋ᵥₑᵣ using Formula 20,
$${v}_{j - ver} = {F}_{dec . AES} ( {[ {\tilde{K}}_{g} \cdot x ]}^{128} , {enc}_{{\tilde{K}}_{g}} ( {v}_{j - ver} ) ) \qquad ( Formula 20 )$$
comparing the incoming key update version with the registered key update version and, if there are missed key updates, calculating the forward data summary values individually in a cyclic manner as in Formula EE, Formulas 21 and 22, multiplying them with the current key pair, and updating the keys,
$$\text{?} - {v}_{j - {ver}_{missed}} rnd \% P \qquad ( Formula EE )$$
$${\tilde{K}}^{-} = {v}_{j - {ver}_{m issed}} {K}^{-} \qquad ( Formula 21 )$$
$${\tilde{K}}^{+} = ( \frac{1}{{v}_{j - {ver}_{missed}}} ) {K}^{+} \qquad ( Formula 22 )$$
after completing all past key renewals, updating the keys for the most recently received value as well,
$$\text{?} = {v}_{j - ver} rnd \% P \qquad ( Formula FF )$$
$${\tilde{K}}^{-} = {v}_{j - ver} {K}^{-} \qquad ( Formula 23 )$$
$${\tilde{K}}^{+} = ( \frac{1}{{v}_{j - ver}} ) {K}^{+} \qquad ( Formula 24 )$$
performing elliptic-curve Diffie-Hellman (ECDH) key exchange using the same asymmetric key group [rnd, K^{±}, K⁼] that the KMF server service and the KME endpoint client application have,
calculating the shared key on the KMF endpoint client application and sending the success code to the KMF server service,
with the success code, the KMF server service calculates the symmetric key on its side and completes the key exchange mutually with the KMF endpoint client application.
